(19) United States
(12) Patent Application Publication
(10) Pub. No.: US 2004/0001483 A1
(43) Pub. Date: Jan. 1, 2004

(54) Distribution and reconstruction of AD-HOC timing signals

(76) Inventors: Kurt E. Schmidt, Burlington, WI (US); David Paul Herd, Guerneville, CA (US); Richard Winkler, Lake Zurich, IL (US); Daniel Angerame, Arlington Heights, IL (US)

Correspondence Address: LAW OFFICES OF MARK C. PICKERING, P.O. BOX 300, PETALUMA, CA, 94953, US

(21) Appl. No.: 10/185,600

(22) Filed: Jun. 27, 2002

(51) Int. Cl. H04L 12/40

(52) U.S. Cl. 370/364

(57) ABSTRACT

Ad-hoc timing signals are transferred from a first circuit to a second circuit by determining a system transit delay, detecting an edge of an ad-hoc signal and the frame and timeslot that correspond with the edge, and regenerating the ad-hoc timing signal based on the system transit delay and the frame and timeslot that correspond with the edge.

### BACKGROUND OF THE INVENTION

1. Field of the Invention

The present invention relates to the distribution of timing signals and, more particularly, to the distribution and reconstruction of ad-hoc timing signals.

2. Description of the Related Art

In a synchronous communication system, timing information is usually embedded in a data stream (e.g., a T1 link or a OC3 link), or provided by a special system reference clock (e.g., a network composite clock). Such systems, however, seldom provide any means of distributing ad-hoc timing information, which is timing information that is not necessarily related in either frequency and/or phase to either the data stream or the composite clock reference.

For example, it is difficult to recover and distribute a TCM-ISDN timing reference (TTR) within a communication system that is synchronized to a transport link, such as OC3. Thus, there is a need for a mechanism that distributes ad-hoc timing signals without consuming normal timing resources and/or degrading system performance.

### SUMMARY OF THE INVENTION

The present invention provides a communication system that distributes ad-hoc timing signals. The communication system includes a first bus that has a first bus clock signal, and a first circuit that is connected to the first bus. The first circuit has a bus master that is connected to the first bus, and a second bus that is connected to the bus master. The second bus has a second bus clock signal. The second bus clock signal and the first bus clock signal have a predefined relationship. The first circuit also has a first timing circuit connected to the second bus. The first timing circuit detects an edge of an ad-hoc clock signal, and defines a position of the edge with respect to the first bus clock signal based on the predefined relationship.

The communications system also includes a second circuit that is connected to the first bus. The second circuit has a bus slave that is connected to the first bus, and a third bus that is connected to the bus slave. The third bus has a third bus clock signal. The third bus clock signal and the first bus clock signal also have a predefined relationship.

The second circuit additionally has a second timing circuit that is connected to the third bus. The second timing circuit forms a regenerated clock signal in response to the position of the edge so that an edge of the regenerated clock signal occurs substantially at a same time that an edge of the extracted clock signal occurs.

The present invention also includes a method of distributing ad-hoc timing signals. The method includes the step of transferring data between a first circuit and a second circuit on a bus that has a bus clock signal. The method also includes the steps of detecting an edge of an ad-hoc clock signal; and defining a position of the edge with respect to the bus clock signal.

A better understanding of the features and advantages of the present invention will be obtained by reference to the following detailed description and accompanying drawings which set forth an illustrative embodiment in which the principals of the invention are utilized.

### BRIEF DESCRIPTION OF THE DRAWINGS

FIG. 1 is a block diagram illustrating an example of a communication system 100 in accordance with the present invention.

FIG. 2 is a block diagram illustrating timing circuit 134 in accordance with the present invention.

FIGS. 3A-3G are timing diagrams illustrating an example of the operation of communication system 100 in accordance with the present invention.

FIG. 4 is a block diagram illustrating a phase-locked-loop (PLL) 400 in accordance with the present invention.

### DETAILED DESCRIPTION

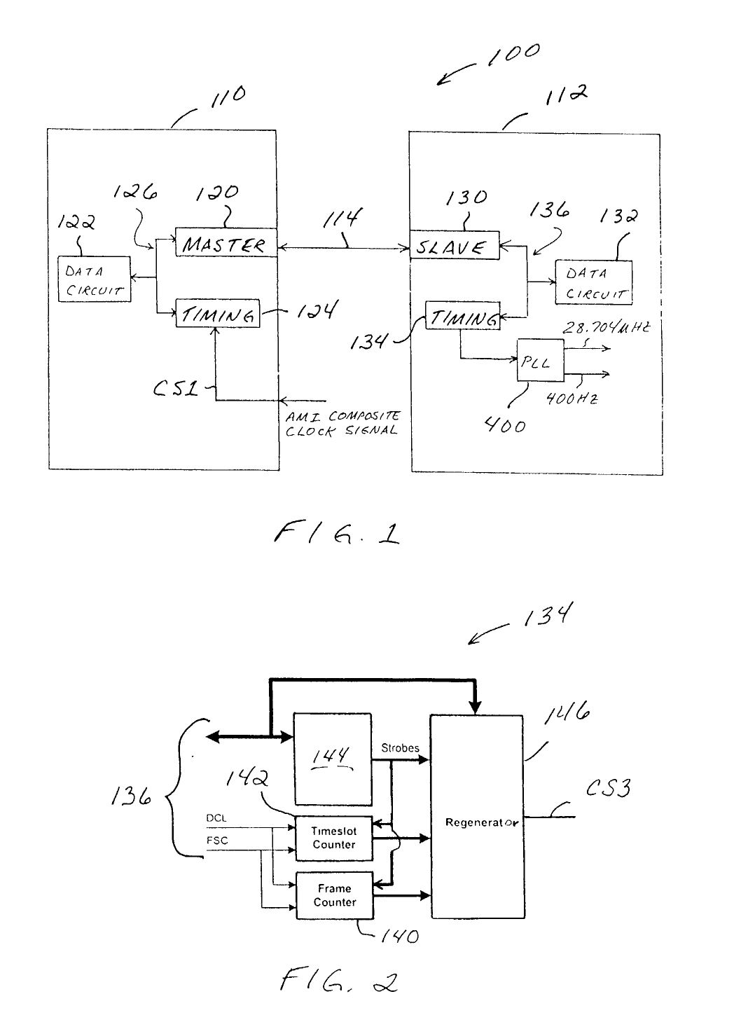

FIG. 1 shows a block diagram that illustrates an example of a communication system 100 in accordance with the present invention. As shown in FIG. 1, system 100 includes a first circuit 110, a second circuit 112, and a bus 114 that is connected to circuits 110 and 112. In operation, first circuit 100 and second circuit 112 exchange data across bus 114. Bus 114 can be statically or dynamically assigned when circuits 110 and 112 are connected together with multiple buses.

In the present example, first circuit 110 includes a bus master 120 that defines the protocol of bus 114, and generates a bus clock signal that defines the timing of bus 114. Bus master 120, which can be implemented as, for example, a wide-band gate array (WBGA), can utilize any of a number of communication protocols, such as time division multiplexing (TDM).

With a TDM protocol, the period of the bus clock signal is divided into a series of time frames. For example, when a series of 16 frames is utilized, the resulting frame sequence for two bus clock periods is frame 00, frame 01, . . . , frame 14, frame 15, frame 00, frame 01, . . . , frame 14, and frame 15. Each frame, which has an equal width, such as 125 uS, is subdivided into a series of timeslots, such as 256 timeslots (000 to 255).

Frames and slots are then assigned to specific devices that are connected to bus 114, and specific data sources within a device. Thus, for example, a first data source within circuit 110 can be assigned to transmit data during timeslot 15 of each frame, while a second data source within circuit 110 can be assigned to transmit data during timeslot 77 of each frame. Similarly, a first data source within circuit 112 can be assigned to transmit data during timeslot 141 of each frame, while a second data source within circuit 112 can be assigned to transmit data during timeslot 253 of each frame.

In addition, the circuits connected to bus 114 that are to receive the data are assigned to receive the data during the specific timeslots. For example, circuit 112 can be assigned to receive data from the first data source of circuit 110 during timeslot 15 of each frame, and from the second data source of circuit 110 during timeslot 77 of each frame.

Similarly, circuit 110 can be assigned to receive data from the first data source of circuit 112 during timeslot 141 of each frame, and from the second data source of circuit 112 during timeslot 253 of each frame. In addition, when a TDM protocol is used, bus master 120 embeds overhead bits that identify each frame.

As further shown in FIG. 1, circuit 110 includes a number of data sources/receivers, including a data circuit 122 and a timing circuit 124, and a bus 126 that is connected to bus master 120, data circuit 122, and timing circuit 124. Timing circuit 124 can be implemented as, for example, a field programmable gate array FPGA. Bus 126, which includes timing signals, has a defined timing relationship with bus 114.

In the present invention, a timing relationship between two buses is defined to be a relationship that allows the timing of one bus to be determined from the timing of the other bus. In the present example, timing circuit 124 can determine the timing of bus 114 from the timing of bus 126.

Circuit 112, in turn, includes a bus slave 130 that is connected to bus 114. Bus slave 130, which can be implemented as, for example, a WBGA, follows the bus protocol and timing defined by bus master 120. Circuit 112 also includes a number of data sources/receivers, including a data circuit 132 and a timing circuit 134, and a bus 136 that is connected to bus slave 130, data circuit 132, and timing circuit 134. Like timing circuit 124, timing circuit 134 can also be implemented as a FPGA. Further, like bus 126, bus 136 includes timing signals, and has a defined timing relationship with bus 114.

In one embodiment of the present invention, timing circuit 124 identifies the edges of a signal, such as a clock signal, and transmits the edge information to timing circuit 134 so that timing circuit 134 can reconstruct the edges of the signal to substantially match the edges of the signal in timing circuit 124. As a result, the edges of the signal occur substantially at the same time in both timing circuits 124 and 134, regardless of the distance between timing circuits 124 and 134.

In one application, timing circuit 124 receives an AMI composite clock signal CS1, and forms a number of binary composite clock signals from the AMI composite clock signal CS1. The binary composite clock signals, which have a clock signal, a p-bit signal, and an n-bit signal, also include an embedded clock signal. Timing circuit 124 determines when the binary composite clock signals are present and valid and, when valid, frames and extracts the embedded clock signal to form an extracted clock signal. The extracted clock signal can be, for example, a 400 Hz clock signal.

In addition to generating the extracted clock signal, timing circuit 124 also detects each rising and falling edge of the extracted clock signal. When an edge of the extracted clock signal is detected, timing circuit 124 determines the TDM frame and timeslot that correspond with the edge. For example, timing circuit 124 could determine that a rising edge of the extracted clock signal occurred during timeslot 129 of frame 02.

As noted above, bus 126 provides timing information to timing circuit 124, and a predefined timing relationship exists between bus 114 and bus 126. Utilizing the timing information and this relationship, timing circuit 124 determines the corresponding TDM frame and timeslot of the edge of the extracted clock signal.

After the edge information has been captured, timing circuit 124 transfers the edge information to bus master 120 via bus 126. The edge information is transferred in a number of bytes, including status bytes, timeslot bytes, and software bytes. Status bytes indicate the edge status of extracted clock signal, and include idle bytes and transition bytes.

A transition byte indicates that a rising or falling edge has been detected, and includes a high transition <Hi Tran> byte that indicates a rising edge has been detected, and a low transition <Low Tran> byte that indicates a falling edge has been detected. An idle byte, on the other hand, indicates that no edge has been detected. In addition, a timeslot byte indicates the number of the timeslot that was present when the edge was detected. (The software byte is described in greater detail below.)

Bus master 120 formats and encodes the edge information, and then transfers the encoded edge information to circuit 112 during the next frame in the timeslot assigned to timing circuit 124. (Timeslot numbers are encoded relative to the frame synch signal of bus master 120 (not absolute bus 114 timeslots).)

Bus slave 130 receives and decodes the edge information, and transfers the edge information to timing circuit 134 via bus 136. Timing circuit 134 utilizes the edge information to regenerate the signal such that the edges in timing circuits 124 and 134 occur at substantially the same time.

FIG. 2 shows a block diagram that illustrates timing circuit 134 in accordance with the present invention. As shown in FIG. 2, timing circuit 134 includes a frame counter 140 and a timeslot counter 142 that are both connected to bus slave 130 to receive a frame synch signal FSC and a data clock signal DCL. The frame synch signal FSC identifies each frame in the series of frames, while the data clock signal DCL identifies when data is valid.

When the frame synch signal FSC and the high transition <Hi Tran> byte are detected, frame counter 140 is reset to a frame delay value, while timeslot counter 142 is reset to zero. The frame delay value represents the system transit time that is required for edge information to pass from timing circuit 124 to timing circuit 134. For example, if a rising edge is detected by timing circuit 124 in frame 02, and edge information regarding the detection is received by timing circuit 134 in frame 06, then a four frame system transit delay is present.

There are two components to the system transit delay. The first component is a frame delay due to the time required to detect and capture an edge, the encoding/transfer delay of bus 126, the transfer delay of bus 114, and the decoding/transfer delay due to bus 136. The second component includes the time difference between the frame synch signals FSC of bus master 120 and bus slave 130, and the state transition delays inside circuits 110 and 112.

Thus, for example, when a four frame system transit delay is present, frame counter 140 is reset to a value of four in response to the frame synch signal FSC and the detection of the high transition <Hi Tran> byte, and is incremented once in response to each subsequent frame synch signal FCS. In addition, timeslot counter 142 is reset to zero in response to the frame synch signal FSC and the detection of the high transition <Hi Tran> byte, and is incremented, for example, 256 times between each frame synch signal FCS using the data clock signal DCL. (In this example, one timeslot equals two data clock periods.)

Timing circuit 134 also includes a synchronizer 144 that is connected to bus slave 130 via bus 136, and an edge regenerator 146 that is connected to bus 136, counter 140, counter 142, and synchronizer 144. Synchronizer 144 detects valid data, and strobes the data into edge regenerator 146 as necessary to capture and route the transition, timeslot, and software bytes (interrupt outputs can be generated and internal status bits can be set). In addition, at least two successive valid idle bytes must be seen before synchronizer 144 considers itself framed. Edge regenerator 146, in turn, regenerates the edges so that the edges of the signal substantially match the edges of the signal in timing circuit 124. When valid data is not present, edge regenerator 146 free runs.

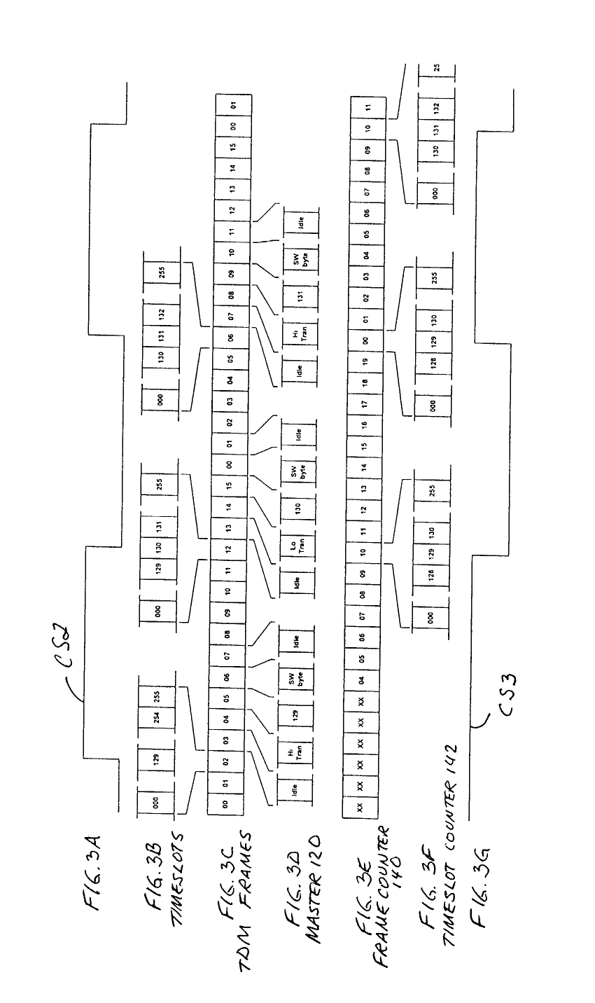

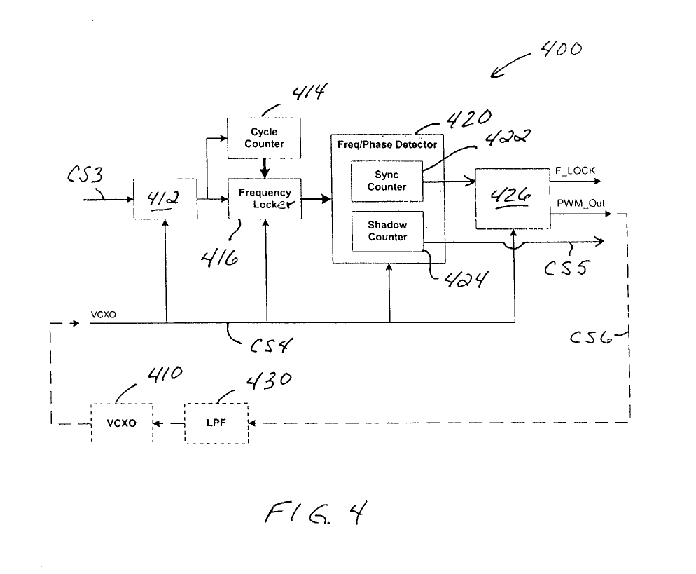

FIGS. 3A-3G show timing diagrams that illustrate an example of the operation of communication system 100 in accordance with the present invention. FIG. 3A shows the extracted clock signal CS2, FIG. 3B shows a series of 256 timeslots that comprise each frame, and FIG. 3C shows a repeating series of 16 TDM frames.

FIG. 3D shows the data output by bus master 120 onto bus 114, and FIG. 3E shows the operation of frame counter 140. In addition, FIG. 3F shows the timeslots associated with each frame, and FIG. 3G shows a regenerated clock signal CS3 that is substantially identical to the extracted clock signal CS2.

As shown in FIGS. 3A-3C, timing circuit 124 detects an edge of the extracted clock signal CS2 in frames 02, 12, 06, and 00 of bus 114. In this example, the first rising edge occurs in timeslot 129 of frame 02. Because clock signal CS2 can be asynchronous to the timing of bus 114, the present example includes a drift of one timeslot per edge between the extracted clock signal CS2 (e.g., a 400 Hz signal) and a timeslot clock that produces, for example, 256 rising edges between each frame synch signal FSC (this represents a very extreme drift).

In frame 03, timing circuit 124 sends a <Hi Tran> byte to bus master 120 via bus 126. As noted above, the <Hi Tran> byte indicates that a rising edge was detected which, in this example, was in frame 02. Further, as shown in FIGS. 3C and 3D, in frame 03, bus master 120 outputs an idle byte <Idle> onto bus 114 in the timeslot pre-assigned to timing circuit 124.

In frame 04, timing circuit 124 sends the detected timeslot number, <129> in this example, to bus master 120 via bus 126. At the same time, bus master 120 puts the <Hi Tran> byte onto bus 114 in the assigned timeslot which, in turn, is received by bus slave 130.

In frame 05, timing circuit 124 sends a software byte <SW byte> to bus master 120 via bus 126. At the same time, bus master 120 puts the <129> byte onto bus 114 in the assigned timeslot which is then received by bus slave 130. In addition, bus slave 130 sends the <Hi Tran> byte to timing circuit 134.

In frame 06, timing circuit 124 sends an idle byte <Idle> to bus master 120 via bus 126. At the same time, bus master 120 puts the software byte <SW byte> onto bus 114 in the assigned timeslot which is then received by bus slave 130. Further, bus slave 130 sends the <129> byte to timing circuit 134 (via bus 136) which stores the <129> byte in a timeslot register.

At the same time, timing circuit 134 recognizes the <Hi Tran> byte and initializes frame counter 140 with the system transit delay which, in this example, is four. In frame 7, bus slave 130 sends the software byte <SW byte> to timing circuit 134 via bus 136. In frame 8, timing circuit 134 stores the software byte <SW byte> in a software byte register.

In the present example, the period of the embedded clock signal CS2, in units of TDM frames, is predetermined and stored in timing circuit 134. In the present example, 20 TDM frames equal one period of the extracted clock signal CS2, and 10 TDM frames equal one-half period of the extracted clock signal CS2.

Thus, as shown in FIGS. 3E-3G, regenerator circuit 146 generates the reconstructed clock signal CS3 with a falling edge when frame counter 140 has a TDM frame count of 10 (the half period point), and timeslot counter 142 has a timeslot count of 129.

In frame 12, timing circuit 124 detects a falling edge in timeslot 130. In frame 13, timing circuit 124 sends a <Lo Tran> byte to bus master 120 via bus 126. In frame 14, timing circuit 124 sends the timeslot number <130> to bus master 120 via bus 126. At the same time, bus master 120 puts the <Lo Tran> byte onto bus 114 in the timeslot assigned to timing circuit 124, which is then received by bus slave 130.

In frame 15, timing circuit 124 sends the software byte <SW byte> to bus master 120 via bus 126. At the same time, bus master 120 puts the timeslot byte <130> onto bus 114 in the pre-assigned timeslot, which is then received by bus slave 130. In addition, bus slave 130 sends the <Lo Tran> byte to timing circuit 134 via bus 136.

In frame 00, timing circuit 124 sends an idle byte <Idle> to bus master 120 via bus 126. At the same time, bus master 130 puts the software byte <SW byte> onto bus 114 in the pre-assigned timeslot, which is then received by bus slave 130. In addition, bus slave 130 sends the timeslot byte <130> to timing circuit 134 via bus 136. At the same time, timing circuit 134 recognizes the transition byte <Lo Tran> as valid but does nothing with it (because, as described below, at the frame boundaries it is possible for timing circuit 124 to capture rising and falling edges in different frames).

In frame 01, bus slave 130 sends the software byte <SW byte> to timing circuit 134 via bus 136. At the same time, timing circuit 134 recognizes the timeslot byte <130> as valid but does nothing with it. In frame 02, timing circuit 134 stores the software byte <SW byte> in the software register.

At the next rising edge, in TDM frame 06, regeneration circuit 146 generates a rising edge of the reconstructed clock signal CS3 when frame counter 140 has a TDM frame count of 00 (the full period point), and timeslot counter 142 has a timeslot count of 129. At the same time, timing circuit 124 detects a rising edge in timeslot 131.

In frame 07, timing circuit 124 sends a <Hi Tran> byte to bus master 120 via bus 126. The <Hi Tran> byte indicates that a rising edge was detected in frame 06. Further, as shown in FIGS. 3C and 3D, in frame 07, bus master 120 outputs an idle byte <Idle> onto bus 114 in the timeslot pre-assigned to timing circuit 124.

In frame 08, timing circuit 124 sends the detected timeslot number, now <131>, to bus master 120 via bus 126. At the same time, bus master 120 puts the <Hi Tran> byte onto bus 114 in the pre-assigned timeslot which, in turn, is received by bus slave 130.

In frame 09, timing circuit 124 sends a software byte <SW> to bus master 120 via bus 126. At the same time, bus master 120 puts the <131> byte onto bus 114 in the pre-assigned timeslot which is then received by bus slave 130. In addition, bus slave 130 sends the <Hi Tran> byte to timing circuit 134.

In frame 10, timing circuit 124 sends an idle byte <Idle> to bus master 120 via bus 126. At the same time, bus master 120 puts the software byte <SW byte> onto bus 114 in the pre-assigned timeslot which is then received by bus slave 130. Further, bus slave 130 sends the <131> byte to timing circuit 134 (via bus 136) which stores the <131> byte in a timeslot register.

At the same time, timing circuit 134 recognizes the <Hi Tran> byte and initializes frame counter 140 with the system transit delay of four. In frame 11, bus slave 130 sends the software byte <SW byte> to timing circuit 134 via bus 136. In frame 12, timing circuit 134 stores the software byte <SW byte> in a software byte register.

Thus, as shown in FIGS. 3E-3G, regeneration circuit 146 generates the reconstructed clock signal CS3 with a falling edge when frame counter 140 has a TDM frame count of 10 (the half period point), and timeslot counter 142 has a timeslot count of 131. Thus, in this example, the extracted clock signal CS2 moves (relative to TDM bus 114) at a rate of two timeslots every 20 TDM frames.

During system initialization, circuit 110 is told by the CPU (not shown) to use a specific bus (in this example bus 114) and a specific timeslot to send out the edge timing information. In addition, circuit 112 is told by the CPU to look for edge timing information on the same bus in the specific timeslot.

Further, during initialization, the software byte <SW byte> is set by timing circuit 124 with a transmit time stamp. When the software byte <SW byte> is received by timing circuit 134, timing circuit 134 returns the value of the software byte <SW byte> via bus slave 130, bus 114, bus master 120 to timing circuit 124.

When the software byte <SW byte> is returned, timing circuit 124 adds a returned time stamp to the data, and determines the round trip transit time of the time stamped software byte <SW byte> in units of TDM frames. From the round trip transit time, timing circuit 124 determines a one-way system transit delay (in units of TDM frames).

A subsequent software byte <SW byte> is then loaded with the system transit delay value, and sent to timing circuit 134. Timing circuit 134 stores the TDM frame value of the system transit delay, and utilizes the TDM frame value to load frame counter 140. After initialization, the content of the software byte <SW byte> can be user defined.

In this manner, a bidirectional embedded data link of, for example, 6.4 kps, can be created between circuits 110 and 112 after initialization. (Alternately, the system transit delay can be determined by timing circuit 134 outputting a transmit time stamp that is returned by circuit 124 where circuit 134 adds the received time stamp and determines the system transit delay.)

Thus, one of the advantages of the present invention is that circuits 110 and 112 can be physically separated by any distance because system 100 determines the system transit delay upon initialization. The system transit delay need not be known ahead of time. As a result, circuits 110 and 112 can be separated by a few feet and share the same backplane, or be separated by a number of kilometers. Alternately, the system transit delay can be determined for a specific location and hard coded into frame counter 140.

In one application, timing circuit 124 is part of a TCM-ISDN timing reference (TTR) card, the extracted clock signal CS2 is a 400 Hz TTR clock signal, and timing circuit 134 is part of an asynchronous digital subscriber line (ADSL) card. In this application, multiple ADSL cards can be utilized, and the edge timing information is broadcast to all of the ADSL cards. In addition, timing circuit 134 includes a phase-lock-loop that locks a clock signal output by a voltage controlled oscillator (VCO) to the regenerated clock signal CS3.

FIG. 4 shows a block diagram that illustrates an example of a phase-lock-loop (PLL) 400 in accordance with the present invention. As shown in FIG. 4, PLL 400 includes a VCO 410 that outputs a VCO clock signal CS4, and a synchronizer 412 that receives the regenerated clock signal CS3 and the VCO clock signal CS4.

In this example, VCO 410 generates a 28.704 MHz clock signal, which is an integer multiple (71,760) of a 400 Hz signal. Synchronizer 412, which is used to avoid set-up and hold-time violations, detects a timing relationship between the rising edges of the regenerated clock signal CS3 and the VCO clock signal CS4.

In addition, PLL 400 includes a cycle counter 414 that counts each cycle (each rising edge) of the 400 Hz regenerated clock signal CS3, and a frequency locker 416 that outputs a rising edge of the 400 Hz regenerated clock signal CS3 after n cycles have been counted. Cycle counter 414 and frequency locker 416 determine how frequently the rising edge of the regenerated clock signal CS3 is passed on.

A phase error can be checked for during every cycle of the 400 Hz regenerated clock signal CS3 (in which case counter 412 and locker 414 are not necessary), or every n cycles of clock signal CS3. If the cycle-to-cycle phase error is only five parts per million, it is not necessary to check for errors during each cycle of the regenerated clock signal CS3 because the phase error is too small. In this case, the phase error can be detected and corrected by only checking for a phase error every n cycles.

As further shown in FIG. 4, PLL 400 includes a frequency/phase detector 420 connected to locker 416 that includes a synch counter 422 and a shadow counter 424. Synch counter 422 is reset to zero by the output from frequency locker 416 and, once reset, counts each rising edge of the VCO clock signal CS4.

Specifically, synch counter 422 begins at zero, counts down to −½ the integer multiple (−35,880) in response to each rising edge of the VCO clock signal CS4, rolls over to a positive value, and then counts down to zero in response to each rising edge of the VCO clock signal CS4. This process continues until the next rising edge of the regenerated clock signal CS3 is passed on by frequency locker 416 and detected by counter 422.

If the VCO clock signal CS4 is phase and frequency locked to the 400 Hz regenerated clock signal CS3, then synch counter 422 has a count value of zero when the next rising edge of the regenerated clock signal CS3 is passed on by frequency locker 416 and detected by counter 422.

If the VCO clock signal CS4 is running a little fast, then the count value passes through zero and ends up with a negative value when the next rising edge of the regenerated clock signal CS3 is passed on and detected. On the other hand, if the VCO clock signal CS4 is running a little slow, then the count value will not have reached zero (and is therefore positive) when the next rising edge of the regenerated clock signal CS3 is passed on and detected.

Shadow counter 424 is also reset by the rising edge of the regenerated clock signal CS3 output by frequency locker 416 and counts each rising edge of the VCO clock signal CS4. However, unlike synch counter 422, shadow counter 424 is reset to an offset value to compensate for the smaller errors that make up the second component of the system transit delay (as described earlier). For example, by the time synch counter 422 has reached zero, shadow counter 424 may have a count of −12.

Shadow counter 424 outputs a shadow clock signal CS5 that is a reconstructed version of the regenerated clock signal CS3. The shadow clock signal CS5 is more accurately phase and frequency aligned with the regenerated clock signal CS3 than is the VCO clock signal CS4.

The increase in accuracy is because the shadow clock signal CS5 accounts for both components of the system transit delay, while the VCO clock signal CS4 only accounts for one component of error (i.e., the frame delay component). The VCO clock signal CS4 can be made to account for both components of the system transit delay, but when implemented in, for example, an FPGA, it requires less logic to implement shadow counter 424.

As further shown in FIG. 4, PLL 400 includes a pulse width modulator 426 that outputs a frequency locked signal F_LOCK that indicates when the VCO clock signal CS4 is locked to the regenerated TTR clock signal CS3, and an output clock signal CS6. (The frequency locked signal F_LOCK and the VCO clock signal CS4 can be output to a digital signal processor.) Modulator 426, in turn, varies the duty cycle of the output clock signal CS6 based on the positive or negative count of synch counter 422. A negative count decreases the duty cycle, while a positive count increases the duty cycle.

In addition, PLL 400 includes a low-pass filter 430 that receives the output clock signal CS6, and outputs a DC voltage in response to the output clock signal CS6. The DC voltage, in turn, adjusts the phase and frequency of the VCO clock signal CS4. When timing circuit 134 is implemented as a gate array, filter 430 and VCO 410 are separately implemented.

It should be understood that the above descriptions are examples of the present invention, and various alternatives to the embodiment of the invention described herein may be employed in practicing the invention. Thus, it is intended that the following claims define the scope of the invention and that methods and structures within the scope of these claims and their equivalents be covered thereby.

What is claimed is:

1. A communications system comprising:
a first bus having a first bus clock signal;
a first circuit connected to the first bus, the first circuit having:
a bus master connected to the first bus;
a second bus connected to the bus master, the second bus having a second bus clock signal, the second bus clock signal and the first bus clock signal having a predefined relationship;
a first timing circuit connected to the second bus, the first timing circuit detecting an edge of an ad-hoc clock signal, and defining a position of the edge with respect to the first bus clock signal based on the predefined relationship; and
a second circuit connected to the first bus, the second circuit having:
a bus slave connected to the first bus;
a third bus connected to the bus slave, the third bus having a third bus clock signal, the third bus clock signal and the first bus clock signal having a predefined relationship;
a second timing circuit connected to the third bus, the second timing circuit forming a regenerated clock signal in response to the position of the edge so that an edge of the regenerated clock signal occurs substantially at a same time that an edge of the extracted clock signal occurs.

2. The communication system of claim 1 wherein each period of the first bus clock signal includes a series of frames, and each frame includes a series of timeslots.

3. The communication system of claim 2 wherein the first timing circuit receives an input signal that has an embedded clock signal, and detects and extracts the embedded clock signal to form the ad-hoc clock signal.

4. The communication system of claim 2 wherein the first timing circuit determines edge information that includes a frame and a timeslot that correspond with the edge of the ad-hoc clock signal.

5. The communication system of claim 4 wherein the first timing circuit transfers the edge information to the second timing circuit.

6. The communication system of claim 5 wherein the edge information is transferred via the second bus, the bus master, the first bus, the bus slave, and the third bus.

7. The communications system of claim 5 wherein user-defined information is transferable from the first circuit to the second circuit with the edge information.

8. The communication system of claim 5 wherein the second timing circuit includes:
a frame counter having a count;
a timeslot counter having a count; and
a regenerator connected to the frame counter and the timeslot counter, the regenerator forming an edge of the regenerated clock signal in response to the count of the frame counter and the count of the timeslot counter.

9. The communication system of claim 8 wherein the frame counter loads a system transit delay value when reset, the system transit delay value representing a number of frames required to transfer the edge information from the first timing circuit to the second timing circuit.

10. The communication system of claim 9 wherein the first timing circuit measures a number of frames required to send information to and receive information back from the second timing circuit.

11. The communication system of claim 10 wherein the first timing circuit determines the system transit delay from the number of frames, and transfers the system transit delay to the second timing circuit.

12. The communication system of claim 9 wherein the second timing circuit measures a number of frames required to send information to and receive information back from the first timing circuit.

13. The communication system of claim 1 wherein the bus master defines the first bus clock signal.

14. The communication system of claim 1 wherein the embedded clock signal is a 400 Hz clock signal.

15. The communication system of claim 1 wherein the edge of the extracted clock signal is a rising edge.

16. The communications system of claim 1 and further comprising a phase-lock-loop connected to the second timing circuit, the phase-lock-loop locking a voltage controlled oscillator clock signal to the regenerated clock signal.

17. A method of distributing ad-hoc timing signals, the method comprising the steps of:
transferring data between a first circuit and a second circuit on a bus, the bus having a bus clock signal;
detecting an edge of an ad-hoc timing signal; and
defining a position of the edge with respect to the bus clock signal.

18. The method of claim 17 and further comprising the step of forming a regenerated clock signal in response to the position of the edge so that an edge of the regenerated clock signal occurs substantially at a same time that an edge of the ad-hoc timing signal occurs.

19. The method of claim 18 and further comprising the steps of:
receiving an input signal that has an embedded clock signal;
detecting and extracting the embedded clock signal to form the ad-hoc timing signal;
determining a system transit delay;
loading a frame counter with the system transit delay when reset;
resetting a timeslot counter when the frame counter is loaded; and
forming the regenerated clock signal when the frame counter and the timeslot counter reach predetermined values.

20. The method of claim 19 and further comprising the step of locking a voltage controlled oscillator signal to the regenerated clock signal.
